(19) United States
(12) Patent Application Publication
(10) Pub. No.: US 2013/0001234 A1
(43) Pub. Date: Jan. 3, 2013

(54) Plastics Container

(75) Inventor: Andrew Glover, Chesham (GB)

(73) Assignee: NAMPAK PLASTICS EUROPE LIMITED, Newport Pagnell, Buckinghamshire (GB)

(21) Appl. No.: 13/634,744

(22) PCT Filed: Apr. 1, 2011
(86) PCT No.: PCT/GB11/00516

§ 371 Date: Sep. 13, 2012

(30) Foreign Application Priority Data
Apr. 20, 2010 (GB) 1006587.8
Apr. 20, 2010 (GB) 1006588.6
Jan. 31, 2011 (GB) 1101615.1

(51) Int. Cl. B65D 1/02; B65D 1/40; B65D 23/10; B29C 49/08

(52) U.S. Cl. 220/606; 264/523; 425/522; 220/604

(57) ABSTRACT

A blow moulded plastics container for storing liquid (e.g., milk) has a body with a central axis intended to be generally vertical during storage. A part line of the container bisects an integral handle on the body. The body defines a footprint having a width which is greater in a middle region than at either longitudinal end of the footprint. The body has opposing side surfaces extending in a direction at least generally aligned with the part line of the container and forming part of the footprint. In one embodiment, the footprint is longer than it is wide and is asymmetrical about a transverse axis extending in a direction perpendicular to said part line. This reduces thinning effects associated with blowing a parison in a mould cavity.

The present invention relates to a plastics container, more particularly, but not exclusively, to a blow moulded plastics container, e.g. of the kind commonly used for transporting or storing milk.

It is known to package milk in lightweight blow moulded plastics containers for retail through supermarkets and the like. Typically, such containers are of the kind having a body with a central axis intended to be generally vertical during storage, a pouring aperture through which the container is filled and emptied of product, and an integral handle for use when carrying the container or when pouring milk from the pouring aperture. The handle defines an aperture or ‘handle eye’ in the body, having an aperture axis extending in a first direction through the body. Said handle eye is usually taller than it is wide. Typically, such containers have a part line extending in a direction perpendicular to said first direction. Moreover, the body typically has a footprint in plan view with a centre point through which said central axis extends.

There is a desire to make such containers as light as possible, whilst ensuring that they remain fit for purpose in delivering the product in a good condition for consumers.

In an attempt to define “fit for purpose”, the UK packaging industry works to an empirical 60N top load force test. If a lightweight plastics container is able to withstand a 60N top load force applied at a rate of 4 mm per second over a set distance, experience shows that it will survive the milk filling and distribution system and retail successfully to the consumer.

At present, for each container of the regular capacity sizes of milk container (e.g. 1 pint, 2 pint, 4 pint, 6 pint or 1 litre, 2 litre etc), there is a weight “ceiling” which means that it is difficult to manufacture a lighter container that is still fit for purpose (e.g. suitable to pass the empirical 60N top load force test).

The present invention has been devised with a view to reducing the weight ceiling of standard capacity containers without compromising structural integrity i.e. the containers remain fit for purpose.

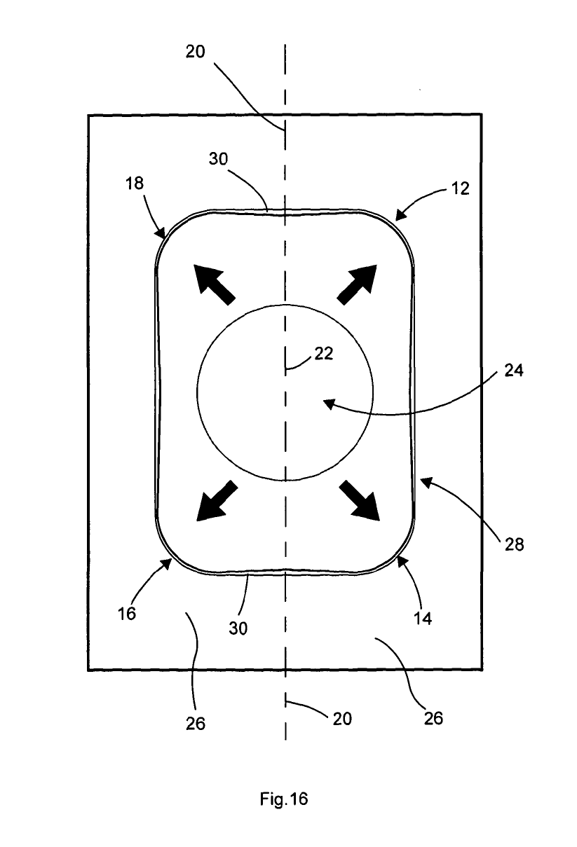

A known blow moulded plastics container for storing milk defines a substantially rectangular footprint in plan view. An example is shown in FIG. 16. The footprint has a notional centreline 20, with two corner regions of the footprint arranged on either side of said centre line 20. All four corner regions 12, 14, 16, 18 of the footprint are equidistant from a centre point 22 of the footprint.

The container is formed by blow moulding a parison 24 in a mould tool 26 having parts that come together to define a generally rectangular mould cavity 28. The tool parts separate along the centre line 22 when ejecting the container 10 from the mould tool. Hence, the centre line 22 in FIG. 16 corresponds to the ‘part line’ of the container which is formed as part of the moulding process.

It will be understood that the split line of the mould tool (and hence the part line of the container) bisects opposing parallel faces of the container. It has been found that the act of blowing a parison in a mould tool configured to form such a container may often lead to aggressive stretching or thinning of the parison wall thickness, particularly in the corner regions where the radial extent of the footprint (relative to the centre point of the footprint) is at its greatest.

The invention provides a container with a footprint that overcomes or mitigates this problem.

According to a first aspect of the invention, there is provided a blow moulded plastics container for storing liquid (e.g. milk) of the kind comprising a body intended to be generally vertical during storage, a pouring aperture through which the container is filled and emptied of liquid, an integral handle, and a part line bisecting the body and the integral handle, wherein the body defines a footprint having a width which is greater in a middle region of the footprint than at either longitudinal end thereof, further wherein the body has opposing side surfaces extending in a direction at least generally aligned with the part line of the container and forming part of the footprint, wherein said footprint is longer than it is wide, and is asymmetrical about a transverse axis extending in a direction perpendicular to said part line.

In effect, the maximum radial extent of the footprint from its centre point is greatest at a point of intersection of the part line, rather than away from the part line (as would be the case for conventional rectangular or square containers). This reduces the tendency for localised thinning of the wall thickness in critical areas during the blow moulding process.

In particular, the stretching or thinning effect on a parison blown in a mould configured to produce a milk container having a footprint in accordance with this aspect of the invention is likely to be less extreme than with conventional containers of the kind referred to above, resulting in more even distribution of plastic within the wall thickness. Moreover, the overall weight of a plastics container may be reduced by adopting this footprint, whilst maintaining storage capacity and the structural integrity necessary to meet the 60N top load force test requirement.

In exemplary embodiments, the footprint includes opposing longitudinal ends arranged along the part line of the container, one of said ends defining divergent portions which extend in a direction at an acute angle to the part line of the container.

In exemplary embodiments, the point of intersection between each divergent portion and a respective side of the footprint is in line with or at least generally aligned with the position of the handle eye.

In exemplary embodiments, the footprint includes opposing longitudinal ends arranged along the part line of the container, one of said ends being generally curved between the opposing sides of the footprint. Said curved end may consist of two curved or radius sections separated by a straight section (e.g. wherein the length of the curved or radius sections is greater than the length of the straight section), or may consist of a continually curving section.

In exemplary embodiments, the divergent portions of the footprint are associated with the handle end of the container and the curved end of the footprint is arranged opposite the handle of the container.

In exemplary embodiments, the opposing sides of the footprint are generally parallel with one another.

In exemplary embodiments, the opposing sides of the footprint are generally parallel with the part line of the container.

In exemplary embodiments, the pouring aperture is concentric with the central axis of the body.

In exemplary embodiments, the integral handle has a main handle portion which is generally upright when the container is in normal storage.

In exemplary embodiments, the integral handle defines a handle eye which is taller than it is wide.

According to another aspect of the invention, there is provided a blow moulded plastics container for storing liquid (e.g. milk) of the kind comprising a body intended to be generally vertical during storage, a pouring aperture through which the container is filled and emptied of liquid, and a part line bisecting the body, wherein the body defines a footprint having a width which is greater in a middle region of the footprint than at either longitudinal end thereof, and further wherein the body of the container has opposing side surfaces extending in a direction at least generally aligned with the part line of the container and forming part of the footprint, further wherein said footprint is longer than it is wide and said footprint is asymmetrical about a transverse axis extending in a direction perpendicular to said part line.

According to another aspect of the invention, there is provided a blow moulded plastics container for storing liquid (e.g. milk) of the kind comprising a body intended to be generally vertical during storage, a pouring aperture through which the container is filled and emptied of liquid, and a part line bisecting the body, wherein the body defines a footprint having a width which is greater in a middle region of the footprint than at either longitudinal end thereof, and further wherein the body of the container has opposing side surfaces extending in a direction at least generally aligned with the part line of the container and forming part of the footprint, said footprint is longer than it is wide, said footprint is symmetrical about said part line and said footprint includes opposing longitudinal ends arranged along the part line of the container, one of said ends having divergent portions which extend at an acute angle to the part line, and the other of said ends defining a significant degree of curvature between the opposing sides of the footprint.

According to a further aspect of the invention, there is provided a blow moulded plastics container for storing liquid (e.g. milk) of the kind having a body intended to be generally vertical during storage, a pouring aperture, and an integral handle defining a handle eye, wherein the handle eye is taller than it is wide and has an aperture axis extending in a first direction through the body; wherein the body has a footprint in plan view with a longitudinal axis extending in a second direction perpendicular to said first direction, the orientation of the longitudinal axis corresponding to the orientation of the part line of the blow moulded container, said footprint having a centre point through which said longitudinal axis extends and having a width which is greater in a middle region of the footprint than at either longitudinal end thereof; and further wherein said footprint is generally octagonal, including first and second pairs of opposing sides, the first pair intersecting the longitudinal axis at a first radial extent and the second pair arranged orthogonal to said first pair and spaced from the longitudinal axis at a second radial extent which is less than the first radial extent.

The above aspect of the invention overcomes the problem of conventional square or rectangular containers (e.g. as discussed above). In effect, the footprint is longer than it is wide, and the maximum radial extent of the footprint from the centre point is greatest along the part line of the container, rather than away from the part line, as in the case of the rectangular container shown in FIG. 16 or a conventional ‘square’ blow moulded container, e.g. of the kind shown in WO99/22994 (Uniloy).

The kind of configuration in accordance with the above aspect of the invention has been found to exhibit less tendency for localised thinning of the wall thickness in critical areas if formed by blow moulding. It has been found that the stretching/thinning effect on the parison in a mould configured to produce a milk container having a footprint in accordance with this aspect of the invention is likely to be less extreme than with conventional mould tools of the kind shown in FIG. 16, resulting in more even distribution of plastic within the wall thickness. Moreover, tests have shown that the overall weight of a plastics container may be reduced by adopting this footprint, whilst maintaining storage capacity and the structural integrity necessary to meet the 60N topload force test requirement.

Preferably, the length of the sides in the first pair is less than the diameter of the pouring aperture.

According to another aspect of the invention, there is provided a blow moulded plastics container for storing liquid (e.g. milk) of the kind having a body with a part line, and wherein the body has a footprint in plan view which is generally octagonal, and includes first and second pairs of opposing sides, the first pair intersecting the part line at a first distance from the centre of the footprint and the second pair arranged orthogonal to said first pair, wherein each side in said second pair is spaced from the part line by a second distance which is less than the first distance.

Preferably, the footprint is generally eight-sided. Preferably, container has a pouring aperture and the length of the sides in the first pair is less than the diameter of the pouring aperture.

In both this and the previous aspect of the invention, the length of the sides in said first pair is preferably less than the length of the sides in said second pair (e.g. preferably at least 20% shorter, more preferably in the region of 25-35% shorter), and/or the centre point of the foot print is concentric with the central axis of the body, and/or the container has a pouring aperture which is concentric with the central axis of the body, and/or wherein at least one of the sides of the footprint is curved, and/or the container has an integral handle with a main handle portion which is generally upright when the container is in normal storage. In embodiments with an integral handle, the part line of the container bisects the integral handle.

In preferred embodiments, the container includes four sides arranged at an angle of inclination to the part line of the container (corresponding to a longitudinal axis of the foot print or the position of the split line of a mould tool configured to form the container by blow moulding), wherein said four sides are of equal length, said length being greater than the length of each of the other four sides of the footprint.

In preferred embodiments, the container is a milk container, i.e. a container intended to be charged with milk at a first location and then distributed and stored for retail at a second location (remote from side first location).

According to a still further aspect of the invention, there is provided a blow moulded plastics container for storing liquid (e.g. milk) of the kind comprising a body with a central axis intended to be generally vertical during storage, a pouring aperture, and an integral handle defining a handle eye, wherein the handle eye is taller than it is wide and has an aperture axis extending in a first direction through the body; wherein the body has a footprint in plan view with a part line extending in a second direction perpendicular to said first direction, said footprint having a centre point through which said part line extends and a width which is greater in a middle region of the footprint than at either longitudinal end thereof; further wherein said footprint has four major sides arranged as two opposing pairs, wherein the sides in the first pair are longer than the sides in the second pair and are at least generally parallel with the part line and at least generally orthogonal to the sides in the second pair, with the part line bisecting the sides in the second pair; and further wherein the footprint includes four truncated corner regions between respective major sides of the footprint, for reducing the stretch required to form the corner regions of the footprint when a parison is blown within a mould tool cavity configured for blow moulding the container.

The above aspect of the invention overcomes the problem of conventional rectangular containers (e.g. as discussed above), by providing a footprint with significantly truncated corner regions, as opposed to a footprint with right angled or rounded corners of the kind shown in FIG. 16. In other words, by effectively removing the four corners of a conventional rectangular footprint, the container in accordance with this aspect of the invention exhibits less tendency for localised thinning of the wall thickness at the corner regions (if formed by blow moulding), compared with containers having conventional rectangular footprints, e.g. of the kind shown in FIG. 16.

It has been found that the stretching/thinning effect on the parison in a mould configured to produce a milk container having a footprint in accordance with this aspect of the invention is likely to be less extreme than with conventional mould tools of the kind shown in FIG. 16, resulting in a more even distribution of plastic within the wall thickness. Moreover, it is suggested that it may be possible to reduce the overall weight of a conventional milk container by adopting this footprint, whilst maintaining storage capacity and the structural integrity necessary to meet the 60N topload force test requirement.

Each truncated corner region is preferably defined by a minor side which extends between the adjacent major sides of the footprint at an angle of inclination to the part line of the container, such that the container preferably has eight sides. This is wholly distinct from a conventional square or rectangular container having curved corners—such containers have only four sides, i.e. the curved transition between the four major sides which forms the corner of the conventional four-sided container cannot be considered to be a ‘side’ or face of the footprint or container.

Hence, the footprint may be defined by removing a generally triangular portion (including the apex) from the corner regions of what would otherwise be a conventional rectangular footprint, thereby resulting in a footprint with eight distinct sides.

In effect, the footprint is still generally rectangular for storage purposes (i.e. so that the containers can be stored side by side in rows and columns on a storage trolley, in an array which has the same effective area as conventional rectangular containers), and with the part line ‘bisecting’ opposing parallel faces of the blown container. The result is an octagon which is symmetrical about the part line, but which is elongated along the direction of the part line; the sides of the footprint parallel with the part line are longer than the sides orthogonal to the part line.

Preferably the footprint is symmetrical about the part line of the container. More preferably, the footprint is also symmetrical about an axis orthogonal to the part line of the container, since this has advantage in storage/transportation and filling line purposes. To that extent, it is preferable for the minor sides to be of equal length.

In preferred embodiments, the length of the minor sides is shorter than the length of the shortest major sides of the footprint, but preferably no less than about 65% of the length of the shortest major side and/or no less than about 50% of the length of the longest major side. The length of the minor sides may be generally the same or greater than the diameter of the pouring aperture.

Other aspects and features of the invention will be apparent from the claims and the following description of preferred embodiments, made by way of example, with reference to the accompanying drawings, in which:

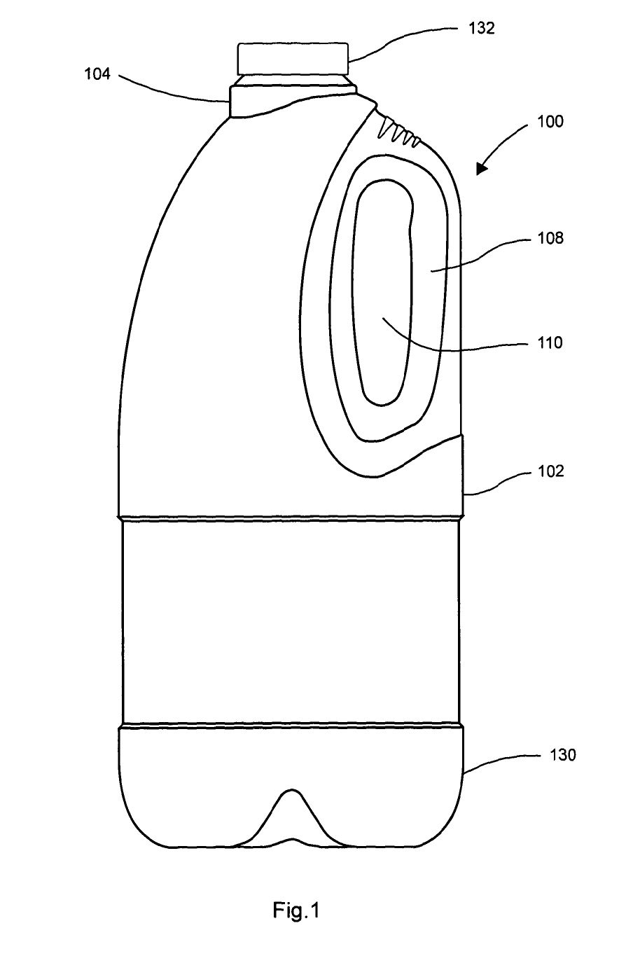

FIG. 1 is a schematic view from the side of a plastics container;

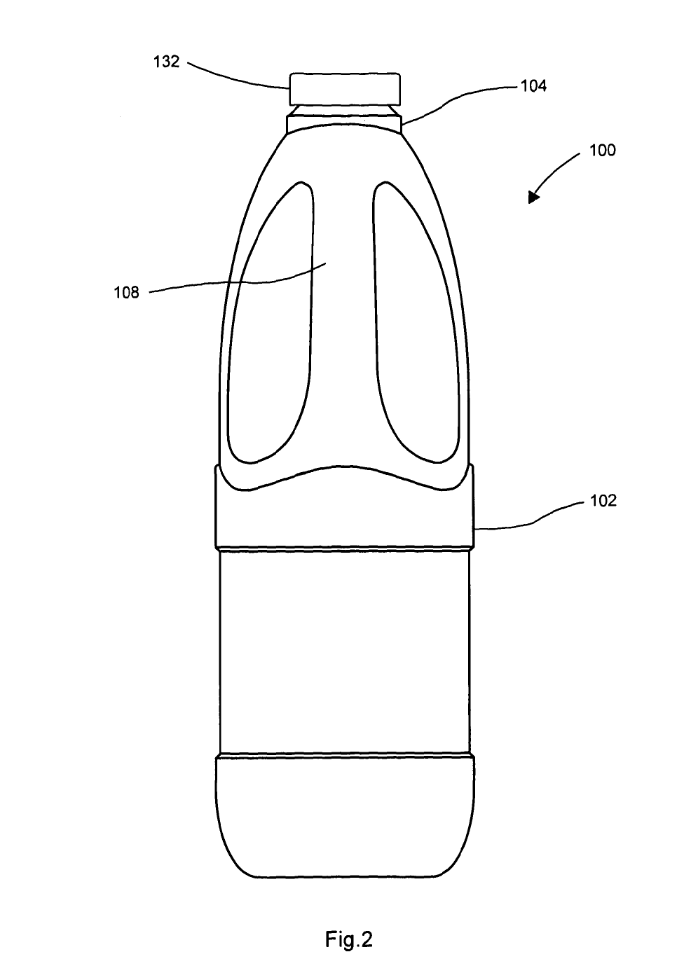

FIG. 2 is a schematic view from one end of the plastics container of FIG. 1;

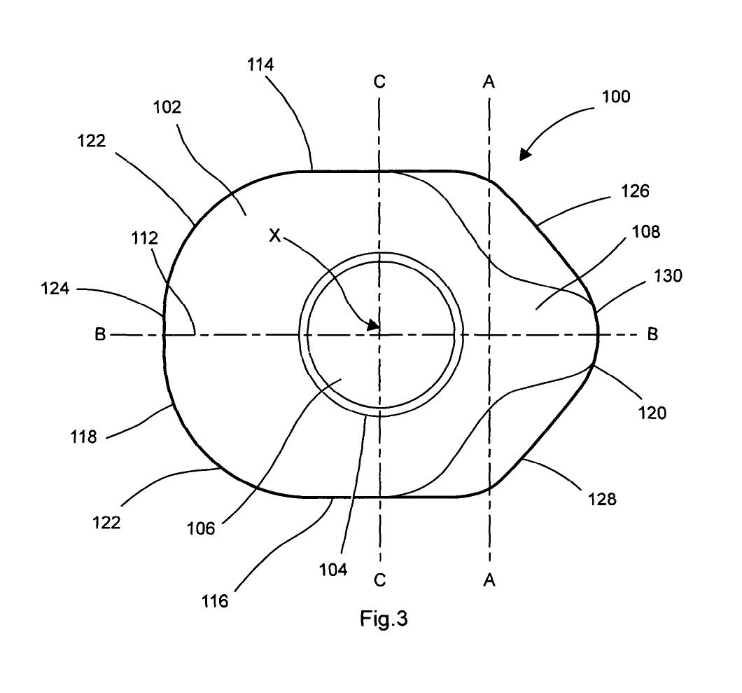

FIG. 3 shows the container of FIGS. 1 and 2 in plan view;

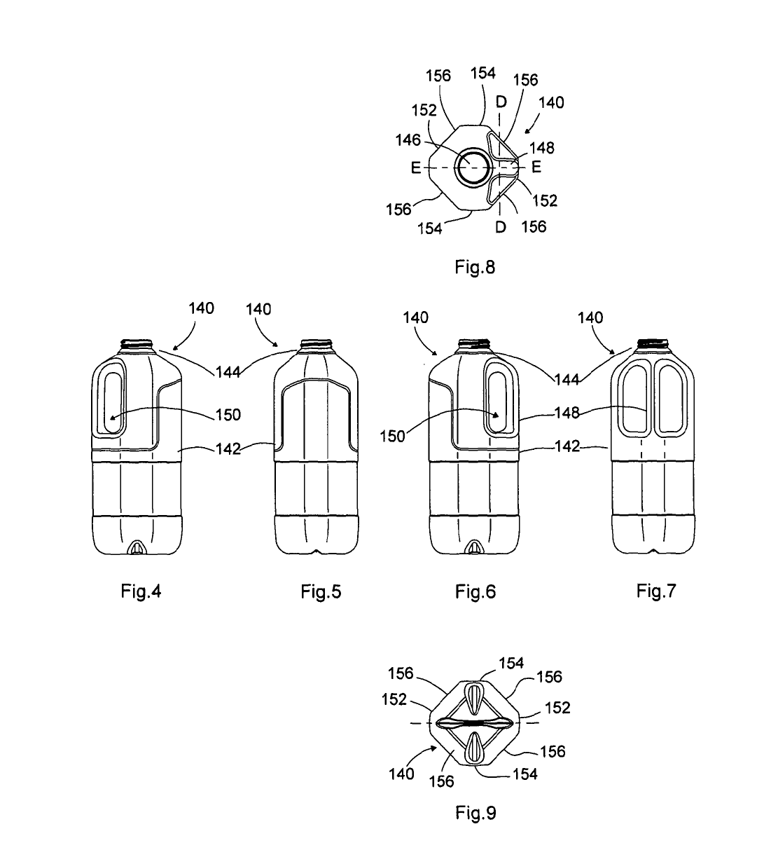

FIG. 4 is a schematic view from the side of another embodiment of a plastics container;

FIG. 5 is a schematic view from the front of the plastics container of FIG. 4;

FIG. 6 is a schematic view from the other side of the plastics container of FIG. 4;

FIG. 7 is a schematic view from the rear of the plastics container of FIG. 4;

FIG. 8 is a schematic plan view from above of the container of FIG. 4;

FIG. 9 is a schematic plan view from below the container of FIG. 4.

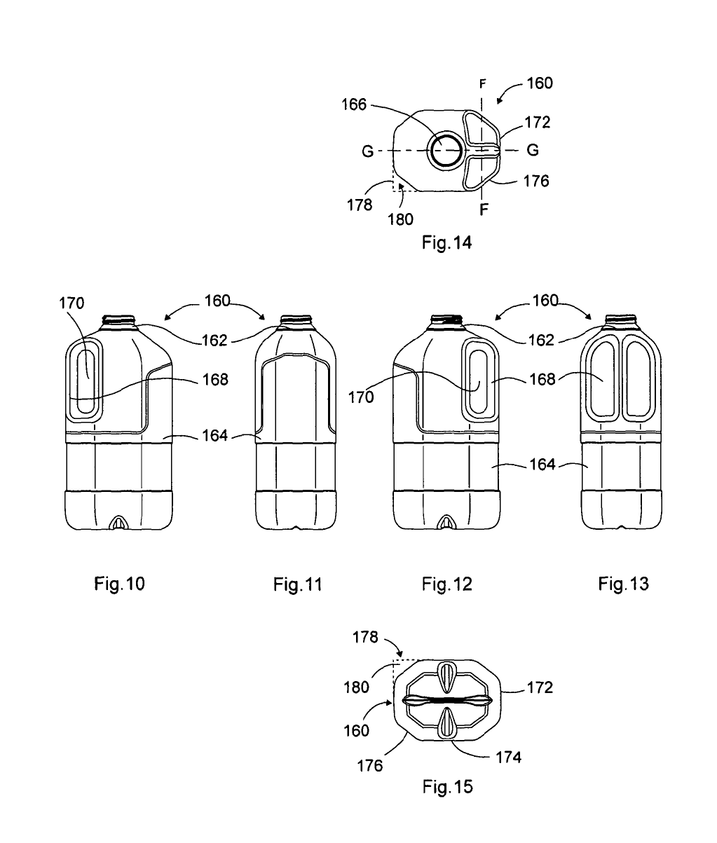

FIG. 10 is a schematic view from the side of another embodiment of a plastics container;

FIG. 11 is a schematic view from the front of the plastics container of FIG. 10;

FIG. 12 is a schematic view from the other side of the plastics container of FIG. 10;

FIG. 13 is a schematic view from the rear of the plastics container of FIG. 10;

FIG. 14 is a schematic plan view from above of the container of FIG. 10;

FIG. 15 is a schematic plan view from below the container of FIG. 10; and

FIG. 16 is a schematic diagram showing a cross-section through a mould tool for blow moulding a known plastics container of substantially rectangular footprint with a split line through opposing parallel surfaces of the footprint.

Referring to FIGS. 1 to 3, a lightweight blow moulded plastics container is indicated generally at 100. The container 100 has a body 102 and a neck 104. The body 102 defines an internal chamber for storing liquid (e.g. milk). The neck 104 extends from the body 102 and defines an open passageway (indicated at 106 in FIG. 3) which communicates with the internal chamber. The container 100 is filled with, and emptied of, liquid through the passageway 106. Hereinafter the passageway is referred to as the pouring aperture 106. As is normal in the art, the pouring aperture 106 may by covered with a hermetic seal.

In this embodiment, the neck 104 is fitted with a conventional cap 132, which provides a replaceable closure for the internal chamber of the container 100.

The container 100 is a milk container, i.e. a container intended to be charged with milk at a first location and then distributed and stored for retail at a second location (remote from side first location). The container 100 is of the kind configured to stand on a planar surface, e.g. on a trolley or refrigerator shelf. More particularly, the body 102, neck 104 and pouring aperture 106 have a common central axis, intended to be generally vertical during storage of the container (i.e. with the rim of the pouring aperture 106 presented generally horizontally). As such, the container 100 may be referred to as a “centre neck” container. Such a configuration is particularly advantageous in reducing foaming effects during the filling of the container with liquid, e.g. milk. However, in other embodiments, the pouring aperture 106 may be offset from the central axis of the body 102.

The body 102 is formed with an integral handle 108 which defines an aperture 110 (hereinafter referred to as the ‘handle eye’). The handle eye 110 is taller than it is wide. In this embodiment, the handle 108 is intended to be generally vertical in use, e.g. parallel with the central axis of the body 102. However, in other embodiments, the handle may be angled relative to the central axis of the body 102.

As shown in FIG. 3, the container 100 has a part line 112, which bisects the body and is formed during the blow moulding process (e.g. corresponding to the location of the split line for the mould tool in which the container is formed).

The part line 112 bisects the integral handle 108. Furthermore, the handle eye 110 defines with a through axis, shown at AA in FIG. 3, which extends in direction perpendicular to the part line 112.

Below the handle eye 110, the body 102 has a cross-section with a longitudinal axis BB (shown in FIG. 3) extending in a direction aligned with the part line 112. The longitudinal axis BB extends through a centre point X of the cross-section. Said cross section defines a footprint of the container 100 (e.g. as viewed in plan).

As can be seen in FIG. 3, the body 102 of the container 100 has opposing side surfaces 114, 116 aligned with the part line 112 of the container 100. The side surfaces 114, 116 are parallel with one another and form opposing sides of the footprint. This parallel-sided configuration has particular advantage for use on automated filling lines. However, in other embodiments, the side surfaces may define a slight curvature or other non-linear configuration, whilst retaining at least a general alignment with the part line 112 of the container 100 (and thereby advantageous alignment on automated filling lines, e.g. relative to opposing guides between which the containers travel on said filling lines).

The footprint has a width which is greater in the middle region than at either longitudinal end, e.g. at the left or right as viewed in FIG. 3. Moreover, the footprint is longer (e.g. in terms of distance long the part line 112) than it is wide (e.g. in terms of distance across the part line 112).

In effect, the footprint defines a significantly truncated rectangle, wherein the maximum radial extent of the footprint from the centre point is greatest along the part line 112 of the container 100, rather than away from the part line 112 (as in the case of conventional rectangular or square containers). This reduces the tendency for localised thinning of the wall thickness in critical areas during the blow moulding process.

The footprint is symmetrical about the part line 112 but asymmetrical about a transverse axis CC extending in a direction perpendicular to said part line 112. In this embodiment, the transverse axis CC bisects the pouring aperture 106 and passes through the centre point X of the footprint.

The footprint includes opposing longitudinal ends 118, 120 arranged along the part line 112 of the container 100. One of said ends 118, opposite the handle 108 (to the left as viewed in FIG. 3) defines a substantially curved end between the opposing sides 114, 116 of the footprint. Said curved end consists of two radius sections 122 separated by a straight section 124. The length of each radius section 122 is greater than the length of the straight section 122. Hence, the curved end provides a significant degree of curvature between the opposing sides of the footprint, and so is clearly distinguished from a conventional rectangular end with rounded corners. In other embodiments, the curved end may consist of a continually curving section. A rounded or substantially rounded front end of the footprint provides improved resistance to bulging, than is the case with square or rectangular containers.

The opposite end 120, associated with the handle 108 (to the right as viewed in FIG. 3), defines a substantially angled end between the opposing sides 114, 116 of the footprint. The angled end 120 of the footprint has divergent portions 126, 128 which extend in a direction at an acute angle to the part line 112 of the container 100. The point of intersection between each divergent portion 126, 128 and the respective side 114, 116 of the footprint is aligned with the position of the handle eye 110, when the container is viewed from the side (e.g. as can be seen in FIG. 1).

The angled end 120 further includes a straight section 130 extending generally perpendicular to the part line 112, and which separates the divergent portions 126, 128. This avoids the use of a sharp corner at the angled end, which might otherwise lead to deformation of the opposite end of another such container when the containers are being moved along a filling line. The straight section 130 is the same length as the straight section 124 on the opposite end of the container 100, and is diametrically opposite the straight section 124. Both sections are parallel with one another. However, in other embodiments, these sections may define a slight curvature, but are nevertheless aligned at least generally perpendicular to the part line, and define generally transverse surfaces for abutment between adjacent containers on a filling line.

Although the footprint of the container 100 is still generally rectangular for storage purposes, insofar as such containers can be stored side by side in rows and columns on a storage trolley in an array which has generally the same effective area as conventional rectangular containers, the novel footprint is wholly distinct from a conventional square or rectangular container. Such containers have a footprint which defines four major sides, i.e. with a first pair of sides arranged orthogonally to a second pair of sides. This is clearly not equivalent to the footprint of FIG. 3.

The stretching or thinning effect on a parison blown in a mould configured to produce a container having a footprint of the kind shown in FIG. 3 is likely to be less extreme than with conventional square or rectangular containers, e.g. of the kind shown in FIG. 16.

Referring now to FIGS. 4 to 9, there is shown a lightweight blow moulded plastics milk container 140. As in the embodiment of FIGS. 1 to 3, the container 140 has a body 142 which defines an internal chamber for storing milk. A neck 144 extends from the body 142 and defines a pouring aperture 146 which communicates with the internal chamber. As is normal in the art, the passageway 146 may by covered with a hermetic seal.

The container is intended to be charged with milk at a first location and then distributed and stored for retail at a second location (remote from side first location). The container 140 is of the kind configured to stand on a planar surface, e.g. on a trolley or refrigerator shelf. More particularly, the body 142, neck 144 and pouring aperture 146 have a common central axis, intended to be generally vertical during storage of the container (i.e. with the rim of the pouring aperture 146 presented generally horizontally). As such, the container 140 may be referred to as a “centre neck” container. However, in other embodiments, the pouring aperture 146 may be offset from the central axis of the body 142.

The body 142 is formed with an integral handle 148 which defines a handle eye 150, which is taller than it is wide. As shown in FIG. 8, the handle eye 150 defines with an aperture axis AA extending in a first direction through the body 142.

Below the handle eye 110, the body 142 has a cross-section with a longitudinal axis BB (shown also in FIG. 9) extending in a second direction which is perpendicular to said first direction. The longitudinal axis BB extends through the centre point of the cross-section. As will be discussed below, the orientation of the longitudinal axis BB corresponds to the orientation of the part line of the blow moulded container 140, and bisects the integral handle 148.

The cross section defines the footprint of the container when viewed from above (in plan view). The length footprint is longer (along the part line than it is wide (across the part line).

As can be seen best in FIG. 9, the footprint is generally octagonal, including first and second pairs of opposing sides 152, 154. The length of the two sides in said first pair 152 is less than the length of the two sides in said second pair 154. As can be seen, the sides 152, 154 follow a slight curvature, although they may follow straight lines in other embodiments.

The configuration is such that the sides 152 in the first pair intersect the longitudinal axis BB at a first distance (D) from the centre point of the cross-section/footprint, and the sides 154 in the second pair (arranged orthogonal to first pair) are spaced from the longitudinal axis BB at a second distance (d) which is less than the first distance (D). The maximum radial extent from the centre point of the sides 152 in the first pair is greater than the maximum radial extent from the centre point of the sides in the second pair 154. Indeed, at any point along the sides 152 in the first pair, the distance from the centre point of the cross section/footprint is greater than the distance from the centre point at any point along the sides 154 in the second pair.

The length of the sides in said first pair is significantly less than the length of the sides in said second pair, preferably at least 20% shorter. In the illustrated embodiment, the sides in the first pair are in the region of 25-35% shorter than the sides in the second pair. In the illustrated embodiment, the length of the sides in the first pair is less than the diameter of the pouring aperture 146.

As can be seen, the container 140 includes a further four sides 156 arranged at an angle of inclination to the part line of the container (corresponding to a longitudinal axis BB of the foot print or the position of the split line of a mould tool configured to form the container by blow moulding), and wherein said four sides are of equal length, said length being greater than the length of each of the other four sides 152, 154 of the footprint.

The maximum radial extent of the cross-section/footprint from the centre point is greatest along the part line of the container (corresponding to longitudinal axis BB).

The radial extent at the other two corner regions is less than the maximum radial extent of the cross section/footprint.

This configuration has been found to be advantageous for a blow moulded product, particularly with respect to reducing wall thinning effects associated with the blow moulding of conventional square or rectangular containers. This has enabled the production of containers which meet the conventional top load test requirements, but which have a reduced weight. This should enable the overall reduction of plastics consumption in plastics milk container production.

Referring now to FIGS. 10 to 15, there is shown a further embodiment of a lightweight blow moulded plastics milk container 160. As in the previous embodiments, the container 160 has a body 162 which defines an internal chamber for storing liquid (e.g. milk), and a neck 164 which extends from the body 162 and defines an open passageway or pouring aperture 166 through which the container 160 is filled with, and emptied of, liquid. The pouring aperture 166 may by covered with a hermetic seal.

The container is intended to be charged with milk at a first location and then distributed and stored for retail at a second location (remote from side first location). The container 160 is of the kind configured to stand on a planar surface, e.g. on a trolley or refrigerator shelf. More particularly, the body 162, neck 164 and pouring aperture 166 have a common central axis, intended to be generally vertical during storage of the container (i.e. with the rim of the pouring aperture 106 presented generally horizontally). As such, the container 160 may be referred to as a “centre neck” container. Such a configuration is particularly advantageous in reducing foaming effects during the filling of the container with liquid, e.g. milk. However, in other embodiments, the pouring aperture 166 may be offset from the central axis of the body 162.

The body 162 is formed with an integral handle 168 which defines an aperture 170 (herein after referred to as the ‘handle eye’), which is taller than it is wide. As shown in FIG. 14, the aperture 170 defines with an aperture axis AA extending in a first direction through the body 162.

Below the handle eye 170, the body 162 has a cross-section with a longitudinal axis BB (shown also in FIG. 15) extending in a second direction which is perpendicular to said first direction. The longitudinal axis BB extends through the centre point of the cross-section. The orientation of the longitudinal axis BB corresponds to the orientation of the part line of the blow moulded container 160, which bisects the integral handle 168.

The cross section defines the footprint of the container 160 when viewed from above (in plan view). As can be seen best in FIG. 15, the footprint has four major sides 162, 164 arranged as two opposing pairs. The two shortest major sides 162 are equal in length, said length being less than the length of each of the other two major sides 164 of the footprint. The part line of the container 160 bisects the two shortest opposing sides of the footprint.

The footprint includes four minor sides 166 which extend between the respective major sides 162, 164 of the footprint at an angle of inclination to the part line of the container 160.

The minor sides 166 have a length which is shorter than the length of the shortest major sides 162 of the footprint. In the most preferred embodiments, the corner regions of the footprint are significantly truncated, e.g. wherein the length of the minor sides is preferably no less than about 65% of the length of the shortest major side 162 and/or preferably no less than about 50% of the length of the longest major side 164. This is believed to provide an effective contribution to the reduction in parison stretch away from the part line, whilst also contributing to structural integrity, particularly in preferred embodiments in which the minor sides 166 are equal in length and the footprint is symmetrical about the part line.

In the illustrated embodiment the length of the minor sides 166 is generally the same as the diameter of the pouring aperture 166.

The effect is to ‘remove’ the right angled or curved corner regions (one of which is indicated in dotted outline at 178 in FIGS. 14 and 15) of what would otherwise be a conventional rectangular container, e.g. of the kind shown in FIG. 16). This may be achieved by effectively cutting off a triangular portion 180 of the rectangular corner region, including the apex of the corner.

Although the footprint is still generally rectangular for storage purposes, insofar as such containers can be stored side by side in rows and columns on a storage trolley in an array which has the same effective area as conventional rectangular containers, it is clear that the footprint has eight distinct sides. The result is an octagon which is symmetrical about the part line, but which is elongated along the direction of the part line; the sides of the footprint parallel with the part line are longer than the sides orthogonal to the part line.

This is wholly distinct from a conventional square or rectangular container having curved corners (e.g. as shown in FIG. 16). Such containers have only four sides, i.e. the curved transition between the four major sides which forms the corner of the conventional four-sided container cannot be considered to be a ‘side’ or face of the footprint or container.

The kind of configuration described with reference to FIGS. 10 to 15 has been found to exhibit less tendency for localised thinning of the wall thickness in critical areas if formed by blow moulding than containers having conventional rectangular footprints (e.g. as shown in FIG. 16).

The configuration of container described with reference to FIGS. 10 to 15 should enable the production of containers which meet the conventional top load test requirements, but which have a reduced weight. Hence, this should enable an overall reduction in the plastics consumption of plastics milk container production.

1. A blow moulded plastics container for storing liquid, the container comprising a body with a central axis intended to be generally vertical during storage, a pouring aperture through which the container is filled and emptied of liquid, an integral handle for use when pouring liquid from the pouring aperture, and a part line bisecting the integral handle, wherein the body defines a footprint having a width which is greater in a middle region of the footprint than at either longitudinal end thereof, and further wherein the body of the container has opposing side surfaces extending in a direction at least generally aligned with the part line of the container and forming part of the footprint, said footprint is longer than it is wide and said footprint is asymmetrical about a transverse axis extending in a direction perpendicular to said part line.

2. A container according to claim 1 wherein the maximum radial extent of the footprint from the centre point of the footprint is greatest along the part line of the container.

3. A container according to claim 1 wherein the footprint further includes opposing longitudinal ends arranged along the part line of the container, one of said ends having divergent portions which extend in a direction at an acute angle to the part line of the container.

4. A container according to claim 3 wherein the point of intersection between each divergent portion and the respective side of the footprint is aligned with the position of the handle eye.

5. A container according to claim 1 wherein the footprint further includes opposing longitudinal ends arranged along the part line of the container, one of said ends defining a substantially curved profile between the opposing sides of the footprint.

6. A container according to claim 5 wherein the curved profile consists of two radius sections separated by a straight section, wherein the length of each radius section is greater than the length of the straight section.

7. A container according to claim 5 wherein the curved profile consists of a continually curving section.

8. A container according to claim 1 wherein the footprint is symmetrical about the part line.

9. A container according to claim 1 wherein the footprint further includes opposing longitudinal ends arranged along the part line of the container, one of said ends having divergent portions which extend at an acute to the part line, and the other of said ends defining a substantially curved profile between the opposing sides of the footprint.

10. A container according to claim 9 wherein the point of intersection between each divergent portion and the respective side of the footprint is aligned with the position of the handle eye.

11. A container according to claim 9 wherein the container includes a transverse wall section extending generally perpendicular to the part line, and which separates the divergent portions at one end of the footprint, and wherein the curved profile consists of two curved or radius sections, and wherein the container includes another wall section extending generally perpendicular to the part line and which separates the two curved or radius sections, wherein the length of each curved or radius section is greater than the length of the associated wall section.

12. A container according to claim 11 wherein the two wall sections are of substantially the same length and are diametrically opposite one another.

13. A container according to claim 1 wherein the opposing sides of the footprint are generally parallel with one another.

14. A container according to claim 1 wherein the opposing sides of the footprint are generally parallel with the part line of the container.

15. A container according to claim 1 wherein the pouring aperture is concentric with the central axis of the body.

16. A container according to claim 1 wherein the integral handle has a main handle portion which is generally upright when the container is in normal storage.

17. A container according to claim 1 wherein the integral handle defines a handle eye which is taller than it is wide.

18. A method for producing a lightweight of a plastics milk container, the method including the steps of providing a mould tool having a cavity for blow moulding a plastics container, wherein the mould tool cavity is configured to provide a container with a cross-section or footprint with a width which is greater in a middle region of the footprint than at either longitudinal end thereof, a cross-section or footprint longer than it is wide and asymmetrical about a transverse axis extending in a direction perpendicular to said part line, with opposing side surfaces extending in a direction at least generally aligned with the part line of the container, for reducing the stretch required to form the footprint when a parison is blown within the mould tool cavity.

19. A mould tool configured for producing a plastics container in accordance with claim 1.

20. (canceled)

21. A blow moulded plastics container for storing liquid of the kind having a body intended to be generally vertical during storage, a pouring aperture, and an integral handle defining a handle eye, wherein the handle eye is taller than it is wide and has an aperture axis extending in a first direction through the body; wherein the body has a footprint in plan view with a longitudinal axis extending in a second direction perpendicular to said first direction, the orientation of the longitudinal axis corresponding to the orientation of a part line of the blow moulded container, and said footprint having a centre point through which said longitudinal axis extends; and further wherein said footprint is generally octagonal, including first and second pairs of opposing sides, the first pair intersecting the longitudinal axis at a first radial extent and the second pair arranged orthogonal to said first pair and spaced from the longitudinal axis at a second radial extent which is less than the first radial extent.

22. A container according to claim 21 wherein the length of the sides in said first pair is significantly shorter than the length of the sides in said second pair.

23. A container according to claim 22 wherein the length of the sides in said first pair is at least 20% shorter than the length of the sides in the second pair, preferably in the region of 25-35% shorter.

24. A container according to claim 22 wherein the length of the sides in the first pair is less than the diameter of the pouring aperture.

25. A container according to claim 21 wherein the centre point of the foot print is concentric with the central axis of the body.

26. A container according to claim 21 wherein the pouring aperture which is concentric with said central axis.

27. A container according to claim 21 wherein at least one of the sides is curved.

28. A container according to claim 21 wherein the integral handle has a main handle portion which is generally upright when the container is in normal storage.

29. A container according to claim 21 wherein the longitudinal axis of the container bisects the integral handle.

30. A method for reducing the weight of a plastics milk container, the method including the steps of providing a mould tool having a cavity for blow moulding a plastics container, wherein the mould tool cavity is configured to provide a container with a cross-section or footprint which defines a generally octagonal shape formed by truncating the corners of an otherwise rectangular footprint, and wherein the mould tool is configured so that two of the ‘corners’ of the rectangle are arranged on the split line of the mould tool, with greater truncation of the other two ‘corners’ of the rectangle (which are arranged on opposing sides of the split line), such that the maximum radial extent of the cross-section/footprint from its centre point is greatest along the part line of the container and the radial extent of the cross-section/footprint at the other two corner regions is less than the radial extent of the cross section/footprint along the part line, in order to reduce the risk of localised thinning occurring when a parison is stretched within the cavity.

31. A plastics container for storing liquid, wherein the container is of the kind having a body with a part line, and wherein the body has a footprint in plan view which is of a generally octagonal shape, and includes first and second pairs of opposing sides, the first pair intersecting the part line at a first distance from the centre of the footprint and the second pair arranged orthogonal to said first pair, wherein each side in said second pair is spaced from the part line by a second distance which is less than the first distance, in order to reduce the risk of localised thinning occurring when a parison is stretched within a mould tool cavity configured for blow moulding the container.

32. A container according to claim 31 wherein the length of the sides in said first pair is significantly shorter than the length of the sides in said second pair.

33. A container according to claim 32 wherein the length of the sides in said first pair is at least 20% shorter than the length of the sides in the second pair, preferably in the region of 25-35% shorter.

34. A container according to claim 21 wherein the container includes four sides arranged at an angle of inclination to the part line of the container (corresponding to a longitudinal axis of the foot print or the position of the split line of a mould tool configured to form the container by blow moulding), and wherein said four sides are of equal length, said length being greater than the length of each of the other four sides of the footprint.

35. A method for reducing the weight of a plastics milk container, the method including the steps of providing a mould tool having a cavity for blow moulding a plastics container, wherein the mould tool cavity is configured to provide a container with a cross-section or footprint which defines a generally octagonal shape formed by truncating the corners of an otherwise rectangular footprint, and wherein the mould tool is configured so that two of the ‘corners’ of the rectangle are arranged on the split line of the mould tool, with greater truncation of the other two ‘corners’ of the rectangle (which are arranged on opposing sides of the split line), such that the footprint includes first and second pairs of opposing sides, the first pair intersecting the part line at a first distance from the centre of the footprint and the second pair arranged orthogonal to said first pair and spaced from the part line at a second distance which is less than the first distance, in order to reduce the risk of localised thinning occurring when a parison is stretched within the mould tool cavity.

36. A process for strengthening plastics milk containers, including the steps of providing a mould tool having a cavity for blow moulding a plastics container, wherein the mould tool cavity is configured to provide a container with a cross-section or footprint which defines a generally octagonal shape formed by truncating the corners of an otherwise rectangular footprint, and wherein the mould tool is configured so that two of the ‘corners’ of the rectangle are arranged on the split line of the mould tool, with greater truncation of the other two ‘corners’ of the rectangle (which are arranged on opposing sides of the split line), such that the maximum radial extent of the cross-section/footprint from its centre point is greatest along the part line of the container and the radial extent of the cross-section/footprint at the other two corner regions is less than the radial extent of the cross section/footprint along the part line, in order to reduce the risk of localised thinning occurring when a parison is stretched within the cavity.

37. A process for strengthening plastics milk containers, including the steps of providing a mould tool having a cavity for blow moulding a plastics container, wherein the mould tool cavity is configured to provide a container with a cross-section or footprint which defines a generally octagonal shape formed by truncating the corners of an otherwise rectangular footprint, and wherein the mould tool is configured so that two of the ‘corners’ of the rectangle are arranged on the split line of the mould tool, with greater truncation of the other two ‘corners’ of the rectangle (which are arranged on opposing sides of the split line), such that the footprint includes first and second pairs of opposing sides, the first pair intersecting the part line at a first distance from the centre of the footprint and the second pair arranged orthogonal to said first pair and spaced from the part line at a second distance which is less than the first distance, in order to reduce the risk of localised thinning occurring when a parison is stretched within the mould tool cavity.

38. A mould tool configured for producing a plastics container in accordance with claim 21.

39. (canceled)

40. A blow moulded plastics container for storing liquid of the kind having a body intended to be generally vertical during storage, a pouring aperture, and an integral handle defining a handle eye, wherein the handle eye is taller than it is wide and has an aperture axis extending in a first direction through the body, wherein the body has a footprint in plan view with a part line extending in a second direction perpendicular to said first direction, said footprint having a centre point through which said part line extends; further wherein said footprint has four major sides arranged as two opposing pairs, wherein the sides in the first pair are longer than the sides in the second pair and are at least generally parallel with the part line and at least generally orthogonal to the sides in the second pair, with the part line bisecting the sides in the second pair; and further wherein the footprint includes four truncated corner regions between adjacent major sides of the footprint, for reducing the stretch required to form the corner regions of the footprint when a parison is blown within a mould tool cavity configured for blow moulding the container.

41. A container according to claim 40 wherein each truncated corner region is defined by a minor side which extends between the adjacent major sides of the footprint at an angle of inclination to the part line of the container, such that the container has eight sides.

42. A container according to claim 41 wherein the length of the minor sides is less than the length of the shortest major sides of the footprint.

43. A container according to claim 42 wherein the length of the minor sides is no less than about 65% of the length of the shortest major side.

44. A container according to claim 42 wherein the length of the minor sides is no less than about 50% of the length of the longest major side.

45. A container according to claim 43 wherein the length of the minor sides is generally the same or greater than the diameter of the pouring aperture.

46. A container according to claim 42 wherein the minor sides are of equal length.

47. A container according to claim 42 wherein the footprint is symmetrical about the part line of the container and about an axis orthogonal to the part line of the container.

48. A container according to claim 40 wherein the footprint is substantially rectangular for storage purposes, for storage in side by side in rows and columns on a storage trolley, in an array which has the same effective area as conventional rectangular containers, but defines an octagon which is symmetrical about the part line, wherein said octagon is elongated along the direction of the part line.

49. A container according to claim 40 wherein the centre point of the foot print is concentric with the central axis of the body.

50. A container according to claim 40 wherein the pouring aperture which is concentric with the central axis of the body.

51. A container according to claim 40 wherein the integral handle has a main handle portion which is generally upright when the container is in normal storage.

52. A method for reducing the weight of a plastics milk container, the method including the steps of providing a mould tool having a cavity for blow moulding a plastics container, wherein the mould tool cavity is configured to provide a container with a cross-section or footprint having four major sides arranged as two opposing pairs, wherein the sides in the first pair are longer than the sides in the second pair and are at least generally parallel with a split line of the mould tool and at least generally orthogonal to the sides in the second pair, and further wherein the footprint includes four truncated corner regions between adjacent major sides of the footprint, for reducing the stretch required to form the corner regions of the footprint when a parison is blown within the mould tool cavity.

53. A method for reducing the weight of a plastics milk container, the method including the steps of providing a mould tool having a cavity for blow moulding a plastics container, wherein the mould tool cavity is configured to provide a container with a cross-section or footprint defined by removing a generally triangular portion (including the apex) from the corner regions of what would otherwise be a conventional rectangular footprint, for reducing the stretch required to form the corner regions of the footprint when a parison is blown within the mould tool cavity.

54. A plastics container for storing liquid, wherein the container is of the kind having a body with a footprint having a centre point through which a part line extends; wherein said footprint has four major sides arranged as two opposing pairs, wherein the sides in the first pair are longer than the sides in the second pair and are at least generally parallel with the part line and at least generally orthogonal to the sides in the second pair, with the part line bisecting the sides in the second pair; and further wherein the footprint includes four truncated corner regions between adjacent major sides of the footprint, for reducing the stretch required to form the corner regions of the footprint when a parison is blown within a mould tool cavity configured for blow moulding the container.

55. A process for producing strengthened milk containers, including the steps of providing a mould tool having a cavity for blow moulding a plastics container, wherein the mould tool cavity is configured to provide a container with a cross-section or footprint having four major sides arranged as two opposing pairs, wherein the sides in the first pair are longer than the sides in the second pair and are at least generally parallel with a split line of the mould tool and at least generally orthogonal to the sides in the second pair, and further wherein the footprint includes four truncated corner regions between adjacent major sides of the footprint, for reducing the stretch required to form the corner regions of the footprint when a parison is blown within the mould tool cavity.

56. A process for producing strengthened milk containers, including the steps of providing a mould tool having a cavity for blow moulding a plastics container, wherein the mould tool cavity is configured to provide a container with a cross-section or footprint defined by removing a generally triangular portion (including the apex) from the corner regions of what would otherwise be a conventional rectangular footprint, for reducing the stretch required to form the corner regions of the footprint when a parison is blown within the mould tool cavity.

57. A mould tool configured for producing a plastics container in accordance with claim 40.

58-65. (canceled)
